(19) United States
(12) Patent Application Publication
(10) Pub. No.: US 2013/0214590 A1
(43) Pub. Date: Aug. 22, 2013

(54) DUAL-ENGINE POWER SYSTEM FOR ELECTRIC VEHICLES TO INCREASE THE RANGE WITHOUT HAVING TO ENLARGE NECESSARY BATTERIES

(71) Applicant: Steve Lin, Jiji Township (TW)

(72) Inventor: Steve Lin, Jiji Township (TW)

(21) Appl. No.: 13/538,970

(22) Filed: Jun. 29, 2012

(30) Foreign Application Priority Data
Feb. 17, 2012 (TW) 101105305

(51) Int. Cl. B60L 1/00

(52) U.S. Cl. 307/9.1; 180/65.21; 903/906

(57) ABSTRACT

A dual-engine power system is provided to improve the power system of the conventional electric vehicles. The vehicle is driven to move by the electric engine. The necessary power/electricity would be provided by the heat engine. Therefore, the range and the endurance battery of the electric vehicles are extended, and the life of the main battery is also improved. Moreover, the complication of design is simplified, and the costs of production and maintain are reduced.

### BACKGROUND OF THE INVENTION

1. Field of the Invention

The present invention relates to an engine power system, and more particularly but not by any way of limitation, to a dual-engine power system adapted for median or large electric vehicles to increase the range of the electric vehicles without having to enlarge the necessary storage batteries.

2. Related Art

Electric vehicles are known having battery packs which drive an electric motor which in turn drives the vehicle wheels. Two types of vehicles are known using electric motors, the first is a hybrid electric vehicle where the vehicle includes an electric motor and an onboard fuel driven engine, where the engine is used to drive the wheels under certain vehicle circumstances.

Another type of electric vehicle also has an onboard fuel driven engine, but the engine is only used to drive a generator, which in turn charges the batteries. The latter type arrangement is referred to as range extender as the onboard engine/generator extends the range that the vehicle can travel on the battery pack before a complete recharge.

With this type of hybrid vehicle, also called electric vehicle with Range Extender, a combustion engine is coupled to an electric machine acting as a generator. The combustion engine delivers its power to the generator, which transforms the rotary motion into electric energy and supplies it to the battery to extend the range (travelling distance of a vehicle without external charge). Alternatively, the electrical energy could be connected to an electric traction motor of the vehicle. In this manner the combustion engine can be operated with a very good efficiency in all operating aspects, which has a positive effect on CO₂ emissions and fuel consumption of the aggregate.

Increasingly, vehicular air-conditioning, especially cooling, is an important accessory in every vehicle, both for passenger comfort and for safety. Drivers in non-air-conditioned vehicles are more tired and more aggressive than air-conditioned counterparts, and are therefore prone to mistakes and errors of judgment. However, an air conditioning system is the largest auxiliary load on a vehicle, using an amount of power that significantly affects vehicle performance. The air-conditioning reduces the range of all-electric vehicles more than 33%.

The fact that the air conditioning system uses a significant amount of power means that a given vehicle must have a larger power the air conditioning unit to retain a desired level of performance. Similarly, this means that a given vehicle must have larger and heavier battery packs to power an air-conditioning unit to retain a desired level of performance.

An additional problem for air-conditioned electric vehicles relates to battery lifetime. As noted above, a battery has a limited number of charge/recharge cycles. When a significant amount of battery power is used for air-conditioning, battery lifetime is reduced, increasing vehicle operating costs.

It would be highly desirable to increase the range of the electric vehicles without having to enlarge the necessary storage batteries.

### SUMMARY OF THE INVENTION

To solve the aforementioned problems of the prior art, the present invention provides a dual-engine power system to increase the range of the electric vehicles and make it possible for the electric vehicles be a cross-country bus.

Accordingly, the present invention discloses a dual-engine power system. The dual-engine power system is adapted to electric vehicles. The dual-engine power system includes an electric engine, a heat engine and a power generator. The electric engine receives a primary electric power from a main battery to drive the electric vehicle to move. The heat engine is adapted to receive a supplemental fuel to generate output power, and driving an air conditioning system directly. The power generator receives the output power generated by the heat engine to generate a secondary electric power to supply a basic power supply system of the electric vehicle.

The heat engine is operated smoothly at a substantially constant revolutions-per-minute (RPM) to reduce the air pollution.

These and other features, aspects, and advantages of the present invention will become better understood with reference to the following description and appended claims. It is to be understood that both the foregoing general description and the following detailed description are examples, and are intended to provide further explanation of the invention as claimed.

### BRIEF DESCRIPTION OF THE DRAWINGS

The present invention will become more fully understood from the detailed description given herein for illustration only, and thus is not limitative of the present invention, and wherein:

FIG. 1 is a respective view of the dual-engine power system in accordance with the present invention;

FIG. 2 is a respective view of the dual-engine power system in accordance with the present invention when using for the electric vehicle;

FIG. 3 is a respective view of another embodiment of the dual-engine power system in accordance with the present invention; and

FIG. 4 is a respective view of the other embodiment of the dual-engine power system in accordance with the present invention.

### DETAILED DESCRIPTION OF THE INVENTION

Reference will now be made in detail to the present preferred embodiments of the invention, examples of which are illustrated in the accompanying drawings. Wherever possible, the same reference numbers are used in the drawings and the description refers to the same or the like parts.

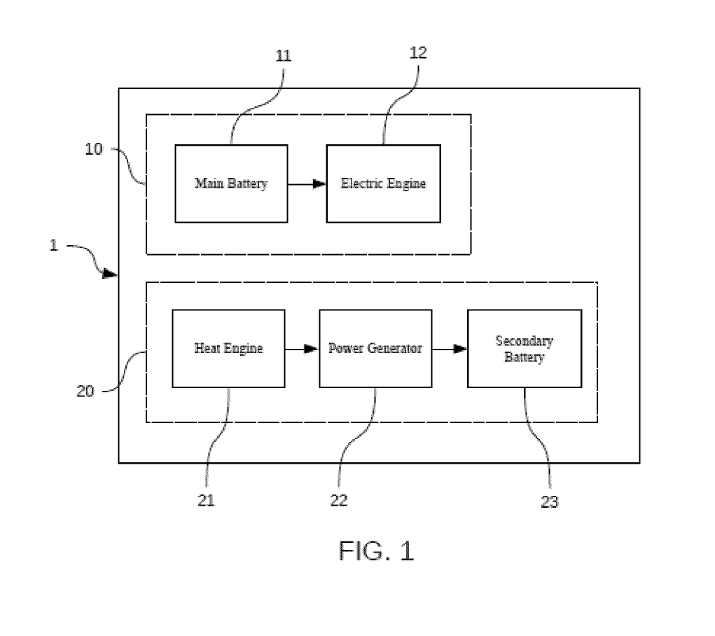

Please refer to FIG. 1, which is a respective view of the dual-engine power system in accordance with the present invention.

The dual-engine power system 1 of this invention is adapted for electric vehicles. The dual-engine power system 1 includes a primary power module 10 and a secondary power module 20. The primary power module 10 includes a main battery 11 and an electric engine 12. The secondary power module 20 includes a heat engine 21, a power generator 22 and a secondary battery 23. The primary power module 10 is utilized to drive the electric vehicle to move and the main battery 11 provides a primary electric power to supply the electric engine 12. Take median electric buses for example, the main battery 11 may be a 350-400 volt battery (pack). The heat engine 21 of the secondary power module 20 is a combustion engine, adapted to receive a supplemental fuel to generate output power. The supplemental fuel may be gasoline fuel, diesel fuel, liquefied petroleum gas, liquefied natural gas, compressed natural gas, or hydrogen fuel. The power generator 22 receives the output power generated by the heat engine 21 to generate a secondary electric power and stored in the secondary battery 23.

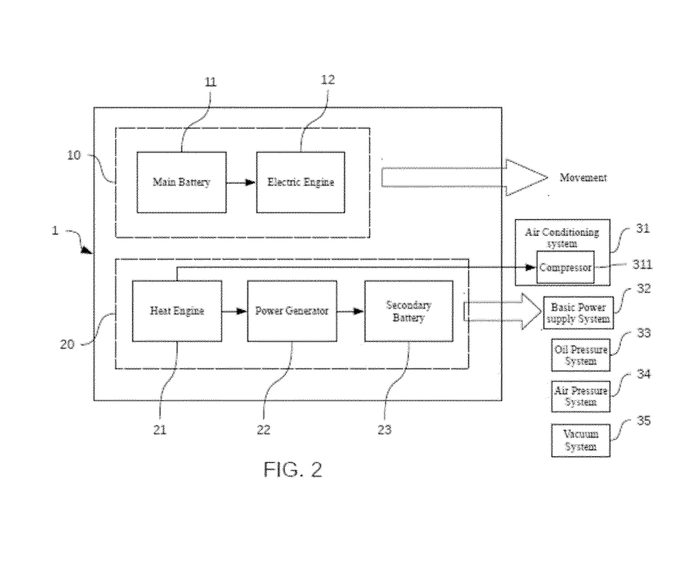

When applying in an electric vehicle, please refer to FIG. 2, the main battery 11 is only used to supply the electric engine 12 to drive the electric vehicle to move. Therefore, with the same capacity, the range of the electric vehicle may be increased about 33%. And the battery lifetime is also increased.

The mechanic power/electric power generated by the secondary power module 20 are supplied to other systems excepting for the movement, such as an air conditioning system 31, a basic power supply system 32, an oil pressure system 33, an air pressure system 34 and a vacuum system 35, etc. For conventional electric vehicles, the air conditioning system 31 is supplied by the main battery 11 after step-down. More than 30% energy of the main battery 11 would be consumed by the air conditioning system 31.

For this invention, the compressor 311 of the air conditioning system 31 is directly driven by the heat engine 21 without using any electric power of the main battery 11. Therefore, the range of the electric vehicle is increased more than 30%, and the lifetime of the main battery 11 is also increased. The electric vehicle operating costs are reduced. Take a city bus, median electric bus, for example, the requirement daily range is 40 kilometers. The cost of the main battery 11 is about 100 thousands dollars. By the dual-engine power system 1 of this invention, the main battery 11 of lower wattage would be sufficient to meet the requirement range. The cost of the main battery 11 is reduced. Furthermore, when the wattage of the main battery 11 is lower, the weight and the volume of the main battery 11 is also reduced. The range would be increased. Moreover, the median electric bus cannot be operated the heating of the air conditioning system 31 due to the load of the main battery 11 is very high. However, by the dual-engine power system 1 of this invention, the heating of the air conditioning system 31 can be operated of the median electric bus.

Take the cross-country bus for example, the requirement daily range is more than 250 kilometers. It is impossible to meet this requirement for the conventional electric bus. However, by the dual-engine power system 1 of this invention, the requirement is meet easily.

The secondary electric power generated by the secondary power module 20 is supplied to the basic power supply system 32, including an instrument board, an interior lighting device, exterior lights and basic controlling system. The external lights may include fog lights, tail lights, brake lights, center-mounted stop lights (CHMSLs), turn signals, back-up lights, cargo lights, puddle lights, license plate illuminators. The secondary electric power further supplies the oil pressure system 33, the air pressure system 34 and the vacuum system 35.

For the conventional electric vehicle, all necessary power for the systems thereof are supplied by the main battery 11. The voltage of the main battery 11 is 300-400 volts. However, the necessary power for the systems are 12, 110, etc. volts. There has a transformer to step-down the voltage to supply the systems. The higher of the voltage of the main battery 11 is, the higher price of the transformer is. And the conversion loss is higher accordingly. Furthermore, the electric vehicle can not be maintain at a traditional car maintenance factory due to the complex electrical circuits and expansive maintenance instrument. Therefore, the electric vehicles are not popular due to the unaffordable prices and maintenance fees. The conventional hybrid cars have the same problems. Hence, the market ratio of the electric vehicles and hybrid cars are limited.

For this invention, the other systems excepting for the movement, such as an air conditioning system 31, a basic power supply system 32, an oil pressure system 33, an air pressure system 34 and a vacuum system 35, etc., are supplied by the secondary power module 20. The cost of the transformer, utilized to step-down the voltage of the main battery 11, is saved. The conversion loss is also reduced. Furthermore, in another viewpoint, the vehicle utilized the dual-engine power system 1 according to this invention is a combustion engine vehicle with the movement system replaced by an electric engine movement module. Therefore, the design and manufacture costs are reduced because of almost the systems or modules of the traditional combustion engine cars can be utilized. Also, it is easy to fabricate for the traditional combustion engine cars factories. And in most situation, the vehicle can be maintain at traditional car maintenance factories. The maintenance fee is also reduced. It is helpful to improve the market ratio of the electric vehicles.

For a median electric bus, the heat engine 21 may be a 350-500 cc engine to supply enough power for other systems. For a car, the heat engine 21 may be a 250 cc or less engine. It is quite smaller than the engine of a traditional combustion engine car. The air pollution is controllable. Also, it is most polluted when the car is accelerated or decelerated for the combustion engine car. However, for our invention, the heat engine 21 is used to drive power generator 22 and the compressor 311. The heat engine 21 can be operated smoothly at a substantially constant revolutions-per-minute (RPM) to reduce the air pollution.

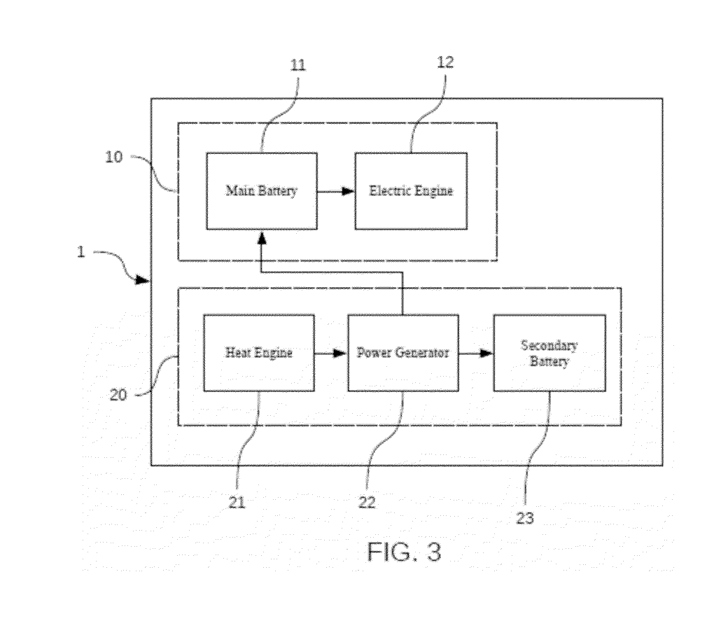

Please refer to FIG. 3, when loads of the secondary power module 20 are low, such as the air conditioning system 31 is idle. The power generator 22 charges the main battery 11 to increase the range.

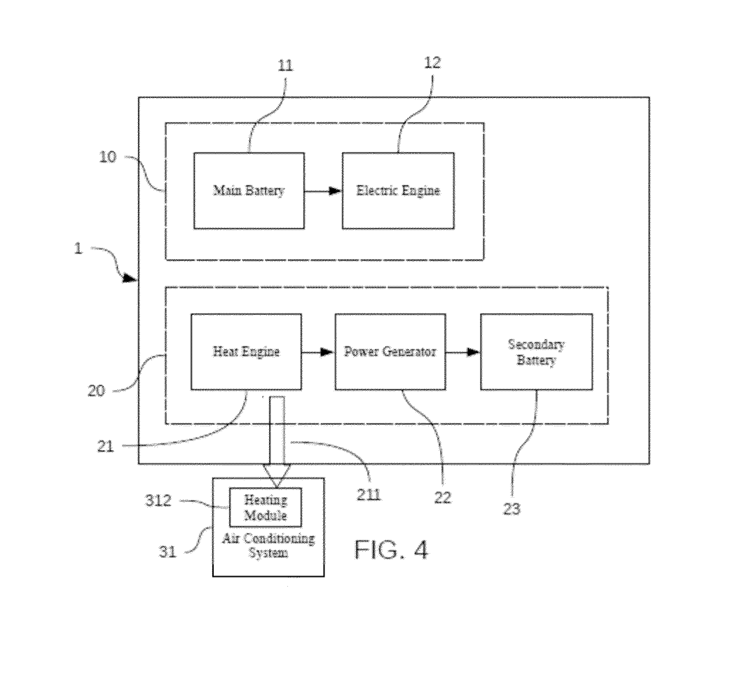

Please see FIG. 4, an exhaust heat 211 of the heat engine 21 is utilized for a heating module 312 of the air conditioning system 31 as a heating source. The greenhouse effect to the environment caused by the exhaust heat 211 is eliminated. And the load of the air conditioning system 31 is reduced to save energy.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A dual-engine power system, adapted for an electric vehicle, the dual-engine power system comprising:
an electric engine, receiving a primary electric power from a main battery to drive the electric vehicle to move;
a heat engine, adapted to receive a supplemental fuel to generate output power, and driving an air conditioning system directly; and
a power generator, receiving the output power generated by the heat engine to generate a secondary electric power to supply a basic power supply system of the electric vehicle.

2. The dual-engine power system of claim 1, wherein the supplemental fuel is selected from the group consisting of gasoline fuel, diesel fuel, liquefied petroleum gas, liquefied natural gas, compressed natural gas, or hydrogen fuel.

3. The dual-engine power system of claim 1, wherein the heat engine is operated smoothly at a substantially constant revolutions-per-minute (RPM).

4. The dual-engine power system of claim 1, wherein the basic power supply system supplies an instrument board, an interior lighting device, exterior lights and basic controlling system.

5. The dual-engine power system of claim 4, wherein the external lights include fog lights, tail lights, brake lights, center-mounted stop lights (CHMSLs), turn signals, back-up lights, cargo lights, puddle lights, license plate illuminators.

6. The dual-engine power system of claim 4, wherein the secondary electric power further supplies an oil pressure system, an air pressure system and a vacuum system.

7. The dual-engine power system of claim 1, further comprises a secondary battery to store the secondary electric power generated by the power generator.

8. The dual-engine power system of claim 1, wherein the heat engine directly drives a compressor of the air conditioning system.

9. The dual-engine power system of claim 1, wherein an exhaust heat of the heat engine is utilized for the air conditioning system as a heating source.

10. The dual-engine power system of claim 1, wherein the main battery is only used to supply the electric engine.
